(19) United States
(12) Patent Application Publication
(10) Pub. No.: US 2001/0023272 A1
(43) Pub. Date: Sep. 20, 2001

(54) Ink jet recording media

(75) Inventors: Gary G. Schiller, Wisconsin Rapids, WI (US); Leonard J. Schliesman, Wisconsin Rapids, WI (US)

Correspondence Address: GREER, BURNS & CRAIN, 300 S WACKER DR, 25TH FLOOR, CHICAGO, IL, 60606, US

(73) Assignee: Stora Enso North America, Corp.

(21) Appl. No.: 09/838,495

(22) Filed: Apr. 19, 2001

Related U.S. Application Data
(63) Continuation-in-part of application No. 09/642,726, filed on Aug. 21, 2000.
Application No. 09/642,726 is a division of application No. 09/097,016, filed on Jun. 12, 1998, now Pat. No. 6,140,406.
Application No. 09/097,016 is a continuation-in-part of application No. 08/672,649, filed on Jun. 28, 1996, now abandoned.
Application No. 09/097,016 is a continuation-in-part of application No. 08/874,166, filed on Jun. 13, 1997, now Pat. No. 6,129,785.

(51) Int. Cl. C08K 3/34; B32B 3/00

(52) U.S. Cl. 524/445; 524/446; 428/195

(57) ABSTRACT

Ink jet recording media have a substrate coated on one or both sides with two layers of coating material. The first layer is a relatively inexpensive ink vehicle absorptive coating comprised in major part of a pigment component that is comprised in major part of relatively inexpensive but highly absorbent calcined clay. The second layer is an ink receptive coating comprised of relatively expensive constituents providing excellent print qualities. Because the first layer provides the important ink vehicle absorbing function, the ink receptive coating can be applied at much lower coat weights than would otherwise be required. This produces recording media having equal or better print qualities than a heavier single layer of the ink receptive material, and does so at much lower cost. Methods of making and applying coatings having high levels of calcined clay are key factors in producing the media.

### CROSS-REFERENCE

This application is a continuation in part of co-pending application Ser. No. 09/642,726 filed Aug. 21, 2000, which is a division of Ser. No. 09/097,016 filed Jun. 12, 1998, now U.S. Pat. No. 6,140,406, which is a continuation-in-part of application Ser. No. 08/672,649 filed Jun. 28, 1996 and Ser. No. 08/874,166 filed Jun. 13, 1997, now U.S. Pat. No. 6,129,785, the disclosures of which are incorporated herein by reference.

### FIELD OF THE INVENTION

The invention relates to ink jet recording media and coating compositions therefor.

### BACKGROUND OF THE INVENTION

High quality ink jet recording media are typically made by applying a single layer of coating to a substrate, such as paper or plastic film. The coating is necessarily designed for multi-functionality, e.g., absorption for rapid ink drying, reactivity to hold out ink colorants at the coating surface for maximum print quality, strength for rub-resistance, wet resistance, water fastness, fade-resistance, etc. The coating layer must be applied in an amount sufficient to provide the multi-functionality, and particularly to provide for absorbency of the ink carrier vehicle needed for rapid drying time. Typical coat weights are five to eight pounds per functional side per 3300 square feet. Some, but not all, of these functions require expensive coating ingredients.

The above identified parent applications disclose an excellent ink jet recording medium comprised of a paper or film substrate coated on one or both sides with an aqueous coating composition containing, by weight, 100 parts of pigment, at least half of which is an absorptive pigment, about 10 to 50 parts binder, about 1 to 10 parts sizing agent and about 2 to 20 parts cationic fixing agent. A preferred embodiment of the coating composition has a pH value of 4.0 to 7.5, more preferably 4.5 to 5.5, and comprises, approximately, in bone dry parts by weight:

75 parts silica gel

25 parts alumina trihydrate

40 parts low molecular weight, partially hydrolyzed polyvinyl alcohol

10 parts polycationic quaternary ammonium polymer

5 parts styrene acrylic dispersion type sizing agent

2 parts whitening agent

The coating composition has a high-solids content and is free from agglomeration and rheology problems, and therefore provides for excellent runability during application of the coating to a substrate, for example paper, by conventional coating equipment, e.g., blade coaters.

When ink jet ink is applied to the coated paper substrate, the absorptive pigment particles in the coating absorb the ink solvent (primarily water) leaving the ink dyes on the surface of the pigment particles. The cationic agent assists in fixing the dyes on the surface. This results in rapid dry time and improved ink holdout and color density. The improved holdout results in enhanced color saturation and better overall print quality and reduces dye penetration to the opposite side of the sheet.

The resultant coated ink jet recording medium is an excellent, high quality product. However, it is quite expensive. The absorptive silica gel is, in particular, an expensive ingredient. Consideration might be given to substituting a less expensive absorptive pigment for some or all of the silica gel, but this would detract from and irreparably denigrate the print quality obtained with the coating composition described.

U.S. Pat. Nos. 4,460,637 and 5,985,424 propose ink jet recording media comprising a substrate bearing two layers of coating compositions having different constituents and different characteristics. In U.S. Pat. No. 4,460,637, one coating composition is comprised of fine silica powder and polyvinyl alcohol in a weight ratio of silica to alcohol of 100:15 on a dry basis. The other composition may be comprised of 15 parts by weight of polyvinyl alcohol and 100 parts by weight of any of ground limestone, talc, polystyrene, silica gel and colloidal silica. Each composition may be used either for the top coating or the base coating (which, considering the substrate, may also be referred to as the intermediate layer).

U.S. Pat. No. 5,985,424 proposes a base coat formulation designed to have high absorptivity for the ink vehicle or solvent and to be compatible in performance with various ink receptive top coat formulations comprised, in this case, of various ratios of fumed silica and styrene-vinylpyrrolidone. The base coat formulation comprises, by weight, 65 to 80% precipitated calcium carbonate, 20 to 30% calcined clay and up to about 10% titanium dioxide, dispersed in a binder comprising 10 to 15% polyvinyl acetate and 2 to 5% soy protein.

Calcined clay is significantly different from the clays customarily employed in the coated paper industry, e.g., kaolin clay. Calcined clay has a high surface area and, when applied as a coating and dried, has an open structure providing a high void volume. In contrast, conventional clays when dried are comparatively dense with little void volume. Because of its high void volume and large surface area, calcined clay is highly absorbent and would serve well to absorb the ink carrier vehicle. Also, it is much less expensive than other absorbent pigments, for example, 5 to 6 times less expensive than silica gel.

On the other hand, calcined clay is very difficult to work with; it adversely affects coating rheology; and it tends to be abrasive, which can cause rapid wear of converting machinery. Consequently, in the manufacture of ink jet recording media, calcined clay has been relegated to use in minor proportions, if at all.

### OBJECTS OF THE INVENTION

An object of the present invention is to provide coatings in which the primary pigment is calcined clay, e.g., wherein the calcined clay comprises more than 50% of the pigment, and preferably 60 to 100% of the pigment.

Another object of the invention is to provide methods or processes for formulating coating compositions with very high levels of calcined clay and for applying the same to substrates.

A further object of the invention is to provide coating compositions containing high levels of calcined clay which are compatible with ink jet holdout coating compositions and which may be employed as a highly absorbent and economical base coating for a more expensive ink receptive top coating.

A still further object of the invention is to provide an ink jet recording medium comprising a substrate coated on one or both sides with two layers of coating materials and wherein a much less expensive first layer provides certain functionalities, especially for ink absorption, and a more expensive second or top layer provides its special print quality functionalities, and wherein the more expensive second or top layer is applied at a thinness such that the two layer coating is more effective and significantly less costly than a single layer coating providing equivalent multi-functionality.

It is in particular an object of the invention to provide an improved and less costly ink jet recording medium comprised of a substrate coated on one or both sides with a first layer of a highly absorbent coating composition containing a high level of calcined clay comprising more than 50%, and preferably 60 to 100%, by weight of the pigment content of the coating, and a second layer comprising a relatively thin coat of the ink jet coating composition of the above-identified parent applications.

### SUMMARY OF THE INVENTION

In accordance with the invention, an improved and less costly ink jet recording medium is comprised of a substrate, an ink carrier vehicle absorptive coating on the substrate and an ink receptive coating overlying the absorptive coating. The absorptive coating is comprised in major part of a pigment component and in minor part of a binder component, and the pigment component is comprised in major part, i.e., more than 50%, of calcined clay. The ink receptive coating is designed primarily to provide desired print surface functionalities, e.g., ink holdout and print quality, and is preferably porous to permit the ink carrier vehicle or solvent (usually water) to be rapidly absorbed by the absorptive coating. Because the absorptive coating provides the important functionality of absorbency, the receptive coating does not need to provide that function and may therefore be applied at a much lower coat weight or thickness than would otherwise be feasible. The two-coat system of the invention, due to the absorbency of the first coat, significantly reduces ink drying time and produces equal or better print quality at much lower cost.

The innovative absorptive coating of the invention is preferably comprised of 100 parts pigment to about 15 to 25 parts binder. Calcined clay comprises more than 50%, and preferably 70 to 100%, of the pigment. The remainder of the pigment, if any, may be any of the pigments customarily employed in paper coating compositions such as hydrous clay or alumina trihydrate. The binder is preferably comprised of 2 to 10 parts protein or starch and 10 to 20 parts latex or polyvinyl alcohol; more preferably, 2 to 7 parts protein and 15 to 20 parts latex.

The invention provides a method or process pursuant to which the constituents of the binder are used in certain combinations, amounts and orders of addition in order to facilitate use of high levels of calcined clay in a coating composition, and to obtain a composition having the coating flow properties (rheology) needed for good application.

When properly formulated and applied, the calcined clay base coating of the invention provides an extremely smooth surface for application thereto of the ink receptive coating; it provides for uniform holdout of the ink receptive coating even when the ink receptive coating is applied at low coat weights; and it greatly enhances absorbency of the ink vehicle and significantly reduces ink drying time. Consequently, the calcined clay base coat of the invention facilitates production of improved ink jet recording media having significantly improved performance characteristics and excellent print quality at substantially reduced cost.

These and other advantages of the invention will become apparent to those reasonably skilled in the art from the following detailed description.

### DETAILED DESCRIPTION OF PREFERRED EMBODIMENTS

The following is a detailed description of preferred embodiments of the invention presently deemed by the inventors to be the best mode of carrying out the invention.

Economic and quality advantages can be achieved in making a high quality coated ink jet sheet for color printing by applying two different coatings on the side or sides of the sheet that will be printed with ink jet ink.

High quality coated ink jet sheets are typically made by applying a single layer of coating to a substrate. This coating is necessarily designed for multi-functionality, and must be comprised of ingredients and applied in an amount sufficient to provide multi-functionality; primarily to provide the absorbency of ink jet ink needed for rapid drying time. Some of the functions require expensive coating ingredients, and coat weights are typically 5 to 8 pounds per 3300 square feet per functional side.

The concept of this invention is to use two coating layers, where a much less expensive first layer provides certain functionality, especially for ink drying, allowing a much reduced weight application of the expensive top layer that provides its special functionalities. Also, judicious use of specially designed materials in the first layer can produce improved print quality.

In accordance with the invention, a highly absorptive first or base layer of coating consists of a pigment and a binder. The pigment is primarily, that is more than 50%, and preferably 70 to 100%, calcined clay. The calcined clay is preferably comprised at least in part of a modified calcined clay having low abrasivity. Suitable modified calcined clays include Ansilex® manufactured by Engelhard Corporation, Iselin, N.J., and Kaocal® manufactured by Thiele Kaolin Company, Sandersville, Ga. The balance of the pigment may include hydrous clays or alumina trihydrate.

Calcined clay has a desirably high surface area. Calcined clay also imparts structure to a dried coating that causes high void volume and resulting absorbency, compared to other coating pigments. However, as heretofore used in coatings for printing papers and as an extender for titanium dioxide, the level of calcined clay has not exceeded about 15% of the pigment. Higher levels of conventional calcined clays have been deemed impractical because of adverse effects on rheology (flow) and objectional levels of abrasiveness.

The present invention provides a means of formulating and applying coatings with very high levels of calcined clay.

In the absorptive first or base-coating layer, calcined clay provides the functionality of absorbing the water of the ink jet ink, providing highly desired fast ink drying, and at the same prevents bleed-through to the opposite side of the sheet—a frequent problem with heavy coverage of four color ink.

The binder can be any of several commonly used in the industry, but must be used in certain combinations, levels and order of addition in order to obtain the coating flow properties needed for good application. Examples are coatings where total binder is comprised of 15 to 25 parts per 100 parts pigment, using 2 to 10 parts protein, casein or starch and 10 to 20 parts latex and/or polyvinyl alcohol. A preferred example is 2 to 7 parts protein, e.g., soy protein, and 15 to 20 parts latex. The latex may be any standard latex, such as styrene butadiene, styrene acrylic, acrylic or vinyl acrylic.

The functionality of the first layer is determined essentially by its thickness, i.e., the amount applied. Because of its much lower cost, the amount applied is not especially critical, so long as it meets the needed functionality, for example, 2 to 9 pounds per 3300 square feet per functional side. 5 to 8 pounds per functional side is usually quite satisfactory.

The absorptive first or base coating has the unique ability to provide (1) a very smooth surface for an ink receptive top coating, (2) a base for uniform holdout of the ink receptive or receptor coating, and (3) an absorptive under layer for quickly absorbing excess ink carrier vehicle, e.g., water. Additionally, the absorptive layer or coating imparts dimensional stability to the recording medium for the reason that it prevents moisture changes in either the substrate or the receptor coating from affecting the medium as a whole. Also, the absorptive base layer permits use of a porous top coat to achieve outstanding improvements in ink drying time.

An ink-receptive top layer is applied over the first or base layer. The top layer may provide some amount of absorbency but is designed primarily to provide print quality functionalities. These customarily require use of expensive coating materials, in particular: a pigment (e.g., silica, which is 5 to 6 times more expensive than calcined clay) comprising 70 to 100% of the pigment; special resins to provide certain surface chemistry characteristics needed to immobilize the ink colorants close to the print surface and to control spreading and wetting; and special binders that provide coating integrity, are compatible with the other ingredients, and aid print quality. The resins and binders may be 3 times and more usually 5 to 6 times the cost of those used in the base layer of the invention. The functionality of the top layer is primarily surface related. Because the less costly first-layer provides the important absorbency for ink drying, the top layer does not need to supply that function and can be applied at a much lower coat-weight for its surface functionality. Pursuant to the invention, the top layer coat-weight may be reduced to a range of 2 to 4 pounds per 3300 square feet per functional side, and still produce equal or better print quality than a heavier single layer, and at a much lower cost.

Further improvements can be achieved by using modified calcined clays in lieu of or in combination with standard calcined clays. Standard calcined clays, while providing absorptivity of ink vehicles, can act as abrasives in converting operations. Modified calcined clays are available that have low abrasivity. Incorporating these into the first coating, part for part with standard calcined clays, will maintain the ink vehicle absorptivity of the coating and yet prevent undesirable abrasivity. As previously noted, suitable modified calcined clays include Englehard Corporations's Ansilex® and Thiele Kaolin Company's Kaocal®.

Pursuant to the present invention, coating compositions containing high levels of calcined clay, i.e., wherein the pigment is comprised of from somewhat more than 50% up to 100% calcined clay, are formulated by mixing together, suitably in a coating composition makedown tank under agitation, the following constituents in the following order:

water,

pigments other than calcined clay, if any,

protein, casein and/or starch,

latex,

other additives, such as lubricants and/or insolubilizers,

dispersant,

calcined clay,

PVOH, if required.

The calcined clay may be composed of a low abrasivity modified calcined clay or a mixture of modified calcined clay and standard calcined clay, for example, a part for part or 50-50 mixture. The calcined clay may be added dry or in the form of a slurry.

If the calcined clay is added dry, it is added near the end of the makedown. If protein, such as soy protein, is in the formulation, and it is preferred that it is, the protein is added as a 15-20% cooked solution just prior to the disperant. The protein acts as a protective colloid for the calcined clay and prevents significant reductions in calcined clay particle size. The disperant is preferably an acrylic disperant, such as Dispex® N-40 available from Allied Colloids, or a chemically similar disperant. The disperant must be added just prior to the addition of the dry calcined clay and also during the addition of the dry calcined clay. The total dispersant requirement is 0.3-0.4 bone dry parts dispersant to 100 bone dry parts calcined clay. The coating is typically 30-45% solids when the dry calcined clay is added. Final coating solids is 45-50%. The coating solids at no time can exceed 55% solids when calcined clay is present and solids in excess of 52% are tolerable only for short periods, less than 10 minutes, during the makedown process.

Slurry calcined clay can be used in the formulations, but the slurry solids must be 45-51%. Slurry solids cannot exceed 51% or porosity and absorptivity may be lost. The same coating solids constraints that apply to dry calcined clay coating makedowns apply to coatings containing slurry calcined as well. The point of addition of slurry calcined clay is less critical than the point of addition for dry. At no time, however, can dry pigments be dispersed in coatings containing slurry calcined clay at solids levels higher than 50%.

Final coating compositions having a solids content of 45-50% provide satisfactory coating rheology. Care should be exercised not to exceed 50% solids. The pigment in the composition may be comprised of from somewhat more than 50% up to 100% calcined clay.

The coating composition may be applied to a substrate by substantially any known coating process or method subject, however, to applying the composition in a much thicker layer than conventional. The final dry coating provided by the invention should have a thickness in the order of about two microns per pound per ream of the desired coat weight. Thus, for a final coat weight of two pounds per ream, the layer of the calcined clay coating of the invention should be about four microns thick, and for a coat weight of nine pounds per ream should be about eighteen microns thick.

The substrate for reception of the coating of the invention may comprise any sheet material customarily employed for ink jet or other printing, such as plastic film or paper. Base papers suitable for the substrate may range in basis weight from 25 to 150 pounds per 3300 square foot ream and may contain groundwood or be groundwood free. The paper may be machine-glazed (MG) or machine finished (MF) and may be uncoated or prime coated. If prime coated, a suitable formulation would comprise equal proportions of calcium carbonate and starch applied at about 4 pounds per 3300 square feet.

The first or base-layer of the calcined clay coating composition of the invention may be applied to the substrate at 2 to 9 pounds per 3300 square feet per side, but is more preferably applied at 5 to 8 pounds per side. The ink receptive top coating may be of any desired composition, but is preferably the composition described in the above-identified parent applications. In any event, by virtue of the advantages provided by the calcined clay base-coating layer, the expensive ink receptive coating layer may be applied at a thinness equal to one-quarter to one-half the amount previously required, i.e., from 2 to 4 pounds rather than 5 to 8 pounds.

The objects and advantages of the invention have thus been shown to be attained in a convenient, economical, practical and facile manner.

While certain preferred embodiments of the invention have been herein described, it is to be appreciated that various changes, rearrangements and modifications may be made therein without departing from the scope of the invention as defined by the appended claims.

What is claimed is:

1. An ink vehicle absorptive coating composition for ink jet recording media comprising a pigment component and a binder component wherein the pigment component is comprised by weight of more than 50% calcined clay.

2. A coating composition as set forth in claim 1 wherein the pigment component is comprised of 60 to 100% calcined clay.

3. A coating composition as set forth in claim 1 wherein the calcined clay is comprised at least in part of a modified calcined clay having low abrasivity.

4. A coating composition as set forth in claim 1 wherein the calcined clay is comprised of approximately equal parts of standard calcined clay and a modified calcined clay having low abrasivity.

5. A coating composition as set forth in claim 1 wherein the binder component is present in the ratio from about 10 to about 25 parts per 100 parts of the pigment component.

6. A coating composition as set forth in claim 1 wherein the binder component is comprised of protein and/or starch and latex and/or polyvinyl alcohol in the approximate ratios of 2-10:10-20.

7. A coating composition as set forth in claim 1 wherein the pigment component is comprised substantially entirely of calcined clay.

8. A coating composition as set forth in claim 7 wherein the binder component is present in the ratio of about 10 to about 25 parts per 100 parts of the pigment component and is comprised of from about 2 to about 10 parts of protein and/or starch and from about 10 to about 20 parts of latex and/or polyvinyl alcohol.

9. An ink jet recording medium comprising a substrate, an ink vehicle absorptive coating on the substrate and an ink receptive coating overlying the absorptive coating,
the absorptive coating comprising a pigment component and a binder component wherein the pigment component is comprised by weight of more than 50% calcined clay and the coating is of a thickness sufficient for rapid absorption of the ink vehicle and rapid drying of the ink,
the receptive coating comprising constituents for reception of ink on the surface of the coating and comprising a thin coating sufficient substantially only for ink reception and holdout.

10. A recording medium as set forth in claim 9 wherein the pigment component of the absorptive coating is comprised by weight of 60 to 100% calcined clay.

11. A recording medium as set forth in claim 9 wherein the pigment component of the absorptive coating is comprised substantially entirely of calcined clay and composed at least in part of a modified low abrasivity calcined clay.

12. A recording medium as set forth in claim 9 wherein the absorptive coating is applied to the substrate at a coat weight of from about 2 to about 9 pounds per 3300 square feet and the receptive coating is applied over the absorptive coating at a coat weight of from about 2 to about 4 pounds per 3300 square feet.

13. A recording medium as set forth in claim 9 wherein the receptive coating comprises a pigment component comprised of at least 50% by weight of a non-agglomerated absorptive silica, a binder and a cationic fixing agent, and has a pH value of less than 7.0.

14. A recording medium as set forth in claim 9 wherein the pigment component of the absorptive coating is comprised substantially entirely of calcined clay and composed at least in part of a modified low abrasivity calcined clay,
the receptive coating comprises a pigment component comprised of at least 50% by weight of a non-agglomerated absorptive silica, a binder and a cationic fixing agent, and has a pH value of less than 7.0, and
the absorptive coating is applied to the substrate at a coat weight of from about 2 to about 9 pounds per 3300 square feet and the receptive coating is applied over the absorptive coating at a coat weight of from about 2 to about 4 pounds per 3300 square feet.

15. A method of making ink jet recording media comprising the steps of
applying to a substrate a layer of an absorptive coating material comprised in major part of a pigment component and in minor part of a binder component and wherein the pigment component is comprised in major part of calcined clay, and
applying over the layer of absorptive material a layer of ink receptive material,
the layer of absorptive coating material being applied at a coat weight of from about 2 to about 9 pounds per 3300 square feet and the layer of ink receptive material being applied at a coat weight of from about 2 to about 4 pounds per 3300 square feet.

16. A method as set forth in claim 15 wherein the calcined clay is comprised at least in part of a modified calcined clay having low abrasivity.

17. A method as set forth in claim 15 wherein the ink receptive material comprises a pigment component comprised of at least 50% by weight of a non-agglomerated absorptive silica, a binder and a cationic fixing agent, and has a pH value of less than 7.0.

18. A method as set forth in claim 17 wherein the binder in the ink receptive material comprises from about 10 to about 50% by weight of the pigment component and the cationic fixing agent comprises from about 2 to about 20% by weight of the pigment component.

19. A method of formulating a coating composition which, when applied to a substrate and dried, is highly absorbent of ink jet carrier vehicles, comprising the steps of mixing together in the following order:
water,
protein, casein and/or starch,
latex,
optional additives such as lubricants and/or insolubilizers,
disperant, and
calcined clay,
the disperant being added to the mixture just prior to and during the addition of the calcined clay.

20. A method as set forth in claim 19 including the step of adding to the water a pigment other than calcined clay.
